(19) United States
(12) Patent Application Publication
(10) Pub. No.: US 2012/0305139 A1
(43) Pub. Date: Dec. 6, 2012

(54) PROCESS FOR COATING STEEL STRIPS AND COATED STEEL STRIP

(75) Inventors: Daniela John, Hannover (DE); Manuel Otto, Cremlingen (DE); Friedrich Luther, Hannover (DE); Christian Fritzsche, Salzgitter (DE)

(73) Assignee: Salzgitter Flachstahl GmbH, Salzgitter (DE)

(21) Appl. No.: 13/508,167

(22) PCT Filed: Oct. 25, 2010
(86) PCT No.: PCT/DE2010/001253

§ 371 Date: Jul. 11, 2012

(30) Foreign Application Priority Data
Nov. 5, 2009 (DE) 10 2009 053 260.9

(51) Int. Cl. C23C 8/26; B32B 15/01

(52) U.S. Cl. 148/230; 148/318

(57) ABSTRACT

In a method for coating steel strips having a base material composition (in weight-%) of: C 0.04-1.0; Mn 9.0-30.0; Al 0.05-15.0; Si 0.05-6.0; Cr≦6.5; Cu≦4; Ti+Zr≦0.7; Nb+V≦0.5, remainder iron including unavoidable steel-incidental elements, the steel strip undergoes annealing and subsequently is coated electrolytically with a coat formed from zinc or a zinc-containing alloy. During the course of annealing of the steel strip at temperatures between 800 and 1000° C. under a N2-H2 containing atmosphere, a surface-near zone is formed which is enriched with nitrides through reaction with elements contained in the steel, thereby preventing molten zinc from penetrating into the base material during welding of the coated steel strip.

The invention relates to a method for coating steel strips with (in weight-%) C 0.04-1.0; Mn 9.0-30.0; Al 0.05-15.0; Si 0.05-6.0; Cr≦6.5; Cu≦4; Ti+Zr≦0.7; Nb+V≦0.5, remainder iron including unavoidable steel-incidental elements, in which the steel strip undergoes final annealing and subsequently is coated electrolytically with a coat formed from pure zinc or a zinc alloy. The steel strip can hereby be cold-rolled as well as hot-rolled.

Furthermore, the invention relates to a steel strip having a respectively composed base material and a metallic coat applied electrolytically thereon.

In view of the beneficial properties with respect to elongation and strength, steels having a high content of manganese, aluminum and/or silicon are suitable for the use in transport vehicles, in particular in the field of automobile construction, and are known as HSD® steels (High Strength and Ductility). Compared to conventional steels, these steels exhibit a significantly smaller specific weight so that the use of these light constructional steels contributes to a significant weight reduction in body construction.

Steels having a high manganese content of 7-30 weight-% are known, e.g., from DE 102 59 230 A1, DE 199 00 199 A1 as well as DE 10 2004 061 284 A1. Flat products produced from these steels have high uniform elongation characteristic at high strength. These advantages are however compromised by the fact that steels with higher contents of manganese have a tendency to pitting and surface corrosion and without the addition of aluminum and/or silicon exhibit little resistance to hydrogen-induced stress fracture corrosion. Therefore, it has already been proposed to also provide flat products of steels having a high manganese content in a manner known per se with a metallic coat to protect the steel against corrosive attack.

It is, for example, known from DE 199 00 199 A1 to enrich and/or coat the surface of the flat product with aluminum. WO 2007/075006 A1 proposes to selectively coat electrolytically or through hot dipping a steel having a high manganese content for production of a flat product in a known manner after undergoing final annealing. Likewise, WO 2006/042930 A1 also proposes a steel having a high manganese content for production of a flat product which is coated using hot dipping treatment.

The known zinc-coated steels of high manganese content have shortcomings because of the inadequate weldability to date as a result of the increased presence of liquid metal embrittlement in the welding zone during welding of galvanized materials.

Welding is to be understood in the following as including all resistance welding processes as well as melt welding or beam welding processes, involving local liquefaction of the zinc coat in addition to the base material.

As a result of welding, the base material encounters an infiltration of the grain boundaries by liquefied zinc material of the coat (liquid metal embrittlement). This infiltration causes the base material to lose strength and ductility in the surroundings of the welding zone to such an extent that the welded connection and the base material adjacent to the welded connection is no longer capable to meet the demands on the mechanical properties so that the risk of premature failure of the welded connection increases.

To improve weldability, DE 10 2005 008 410 B3 discloses for light constructional steel having a high manganese content and coated by hot dipping to apply before final annealing an aluminum layer onto the cold strip, using PVD (Physical Vapor Deposition) onto which the metallic coat is applied after undergoing final annealing. The presence of the intermediate Al layer is intended to prevent zinc from the hot dipping coating during welding to penetrate the microstructure of the steel material and to cause liquid metal embrittlement. The application of such an intermediate layer is very cost-intensive and there is no mentioning of any improvement of the weldability when electrolytically galvanized steels of high manganese content are involved.

Starting from the afore-described state of the art, the invention is based on the object to provide a cost-efficient method to enable a significant improvement of the weldability of electrolytically galvanized steel strips of high manganese content without applying a further metallic intermediate layer.

The posed object is solved by forming in steel strips, which have (in weight-%) C 0.04-1.0; Mn 9.0-30.0; Al 0.05-15.0; Si 0.05-6.0; Cr≦6.5; Cu≦4; Ti+Zr≦0.7; Nb+V≦0.5, remainder iron including unavoidable steel-incidental elements, during the course of annealing of the steel strip at temperatures between 800 and 1000° C. under a N2-H2 containing atmosphere through reaction with elements contained in the steel, a surface-near zone which is enriched with nitrides to prevent a penetration of molten zinc into the base material during welding of the coated steel strip.

Tests have surprisingly shown that the formation of the surface-near nitrided case in accordance with the present invention effectively prevents the molten zinc from attacking the grain boundary during welding of steels of high manganese content. During annealing in accordance with the present invention, i.a., aluminum contained in the steel reacts with nitrogen from the annealing atmosphere near the surface to form aluminum nitride. The surface-near nitrides obtained during annealing of the steel strip are also formed, inter alia, in the region of the grain boundaries to thereby create an effective barrier which prevents the molten zinc from infiltrating during welding.

An essential criteria for attaining an improved weldability of steels of high manganese content is the establishment of a defined nitration depth which, on one hand, has to be great enough to prevent a grain boundary attack by the molten zinc, but small enough to still maintain the demanded technological characteristic values of the steel strip, on the other hand. This is realized in accordance with the invention by the targeted selection of annealing temperature, furnace atmosphere, and retention time.

Tests have shown that the thickness of the nitrided case in the surface-near region of the base material amounts to at least 1 μm but should not exceed a thickness of 50 μm.

Nitration depths between 5 and 25 μm and in particular between 5 and 15 μm have proven advantageous with respect to improved weldability and only slight impact the technological characteristic values of the steel strip.

The formation of the aluminum nitride layer in accordance with the invention is realized at annealing temperatures from about 850° C. At higher annealing temperatures, the annealing time decreases which is necessary for achieving the required nitration depth. At lower annealing temperature, the annealing time has to be prolonged accordingly in order to establish the same nitration depth. Tests of cold strips have shown that annealing temperatures of 900-950° C. are advantageous, with the required nitration depth being established at typical run-through times in continuous annealing facilities.

The advantages of the method according to the invention are seen, on one hand, in a substantially improved weldability of electrolytically galvanized steel of high manganese content, and, on the other hand, the formation of the nitrided case in accordance with the invention can be realized during annealing of the steel strip which is required in any event, merely by a respective annealing atmosphere and respective adjustment of the annealing parameters in a very cost-efficient manner with known and existing large-scale aggregates.

For example a steel having a composition (in weight-%) of C 0.7; Mn 15; Al 2.5; Si 2.5; remainder iron including unavoidable steel-incidental elements, is cast on a strip casting facility into a billet which is rolled into a hot strip. The hot strip is pickled in a conventional manner, subsequently cold rolled, and then subjected to the annealing treatment according to the invention for producing a surface-near nitrided case. Thereafter, the strip undergoes alkaline cleaning, and an activation of the surface before zinc is applied electrolytically in a known manner.

The cold strip galvanized in this way meets the demands for an adequate corrosion protection and can also be sufficiently welded without encountering liquid metal embrittlement.

In addition to the superior technological properties, like very high formability, little sensitivity for edge cracking, high force level with respect to shear tension and cross tension of resistance spot-welded connections, the cold strip exhibits also a high fatigue strength and high resistance to hydrogen-induced stress fracture corrosion compared to like high-strength materials.

What is claimed is:

1.-9. (canceled)

10. A method for coating a steel strip having a base material of a composition which includes, in weight-%, C 0.04-1.0; Mn 9.0-30.0; Al 0.05-15.0; Si 0.05-6.0; Cr≦6.5; Cu≦4; Ti+Zr≦0.7; Nb+V≦0.5, remainder iron including unavoidable steel-incidental elements, said method comprising:
annealing the steel strip at a temperature between 800 and 1000° C. under a N2-H2 containing atmosphere to form a surface-near nitrided case enriched with nitrides through reaction with elements of the composition of the base material; and
electrolytically coating the steel strip with a coat formed from zinc or a zinc-containing alloy, with the surface-near nitrided case preventing molten zinc from penetrating into the base material when the coated steel strip is welded.

11. The method of claim 10, wherein a nitration depth of greater than 1 μm and not greater than 50 μm is formed by varying at least one parameter selected from the group consisting of annealing time and annealing temperature.

12. The method of claim 10, wherein a nitration depth of greater than 1 μm and not greater than 25 μm is formed by varying at least one parameter selected from the group consisting of annealing time and annealing temperature.

13. The method of claim 10, wherein a nitration depth of greater than 5 μm and not greater than 15 μm is formed by varying at least one parameter selected from the group consisting of annealing time and annealing temperature.

14. The method of claim 10, wherein aluminum nitrides are predominantly formed during annealing of the nitrided case.

15. The method of claim 10, wherein the annealing temperature is 900-950° C.

16. A steel strip, comprising:
a base material having a composition, in weight-%, of C 0.04-1.0; Mn 9.0-30.0; Al 0.05-15.0; Si 0.05-6.0; Cr≦6.5; Cu≦4; Ti+Zr≦0.7; Nb+V≦0.5, remainder iron including unavoidable steel-incidental elements;
a metallic coat applied electrolytically on the base material; and
a nitrided case formed in a surface-near zone of the base material to prevent penetration into the base material of molten zinc when the coated steel strip is welded.

17. The steel strip of claim 16, wherein the nitrided case is formed from aluminum nitrides.

18. The steel strip of claim 16, produced by a method set forth in claim 10.
